(19) United States
(12) Patent Application Publication
(10) Pub. No.: US 2013/0033427 A1
(43) Pub. Date: Feb. 7, 2013

(54) IMAGE INPUT SYSTEM AND IMAGE INPUT METHOD THEREOF

(71) Applicant: Kuan-Hao Chen, Jiangxi (CN)

(72) Inventor: Kuan-Hao Chen, Jiangxi (CN)

(73) Assignees: INVENTEC APPLIANCES (PUDONG) CORPORATION, Shanghai (CN); INVENTEC APPLIANCES (NANCHANG) CORPORATION, Jiangxi (CN); INVENTEC APPLIANCES CORP., New Taipei City (TW)

(21) Appl. No.: 13/565,816

(22) Filed: Aug. 3, 2012

(30) Foreign Application Priority Data
Aug. 5, 2011 (CN) 201110223731.9

(51) Int. Cl. G09G 5/08

(52) U.S. Cl. 345/157

(57) ABSTRACT

An image input system and an image input method thereof are disclosed. The system includes an input equipment which includes an image capturing module and a first communication module, and a processing apparatus which includes a second communication module, a calculation module and a conversion module. The image capturing module is configured to capture an image of an object on a display and to detect an image-capturing distance or a position of the object. The captured image, the image-capturing distance or the object position is then communicated to the processing apparatus and may be analyzed by the calculation module to calculate an edge position of the image. The conversion module is configured to convert the edge position, the captured image or the object position to an input signal. This invention creates a new type of human-machine interface through the image capturing module, and the first and second communication modules.

### CROSS-REFERENCE TO RELATED APPLICATION

This application claims the priority benefit of China application serial no. 201110223731.9, filed on Aug. 5, 2011. The entirety of the above-mentioned patent application is hereby incorporated by reference herein and made a part of this specification.

### BACKGROUND OF THE INVENTION

1. Field of the Invention

The invention relates to an image input system and an image input method thereof, in particular, related to an image input system through image capturing and transmission and an image input method thereof.

2. Description of Related Art

Generally speaking, technology products usually have advantages like fast transmission and humanistic operation. And for interface equipments of computers, input equipments like a mouse, a keyboard or a touch screen are very common to facilitate users to input messages or instructions to electronic products.

Taking mouse as an example, which is a very common input equipment of computers, a mouse can position a cursor on the screen and perform operations to the passed position of the cursor by buttons and scrolls. In general, a mouse can be categorized into types of wired transmission and wireless transmission. The mouse adopted wired transmission can transmit signal through dedicated interface, adaptors, RS-232-C, PS/2 interface or universal serial bus (USB). The wireless transmission can transmit signals by using infrared, radio or Bluetooth. However, there exists distance limits among wired or wireless transmission of the mouse, and input mistakes may be caused by low accuracy of cursors.

### SUMMARY OF THE INVENTION

In view of problems in the prior art, an object of the invention is to provide an image input system and an image input method thereof, to implement, create, or enable a new type of human-machine interface by capturing and transmitting images.

According to an object of the invention, the invention provides an image input system with a display. The image input system includes an input equipment and a processing apparatus. The input equipment includes an image capturing module and a first communication module. The image capturing module includes a detection unit and is configured to capture an image of an object on the display and optionally to point toward the object. The detection unit is configured to detect the image capturing module's distance from the object when capturing the image, or a position of the object on the display. The first communication module is configured to communicate the captured image, the image-capturing distance or the object position. The processing apparatus includes a second communication module, a calculation module and a conversion module. The second communication module is configured to receive the captured image, the image-capturing distance or the object position from the first communication module. The calculation module is configured to analyze the captured image, the image-capturing distance or the object position to calculate an edge position of the image. The conversion module is configured to convert the edge position, the captured image or the object position to an input signal.

According to an embodiment of the invention, the processing apparatus includes the display for displaying the image. Moreover, the image capturing module may include a pointing unit electrically connected to the detection unit, and may be configured to capture the image upon the detection unit detecting that the pointing unit is used to point toward the object. In an embodiment of the invention, the image capturing module comprises a beam projector electrically connected to the pointing unit, and the beam projector is configured to project a beam toward the object upon a control button or sensor of the pointing unit being pressed.

According to an embodiment of the invention, the edge position of the image is calculated based on a boundary of the captured image determined by the calculation module analyzing the image-capturing distance or the object position.

According to an embodiment of the invention, the calculation module is configured to calculate the edge position of the image based on the captured image continually captured by the image capturing module.

According to an object of the invention, the invention also provides an image input method applicable to an image input system with a display, wherein the image input system includes an input equipment and a processing apparatus. The method includes the following steps: the input equipment capturing an image of an object on the display, wherein the input equipment is configured to point toward the object; the input equipment detecting the input equipment's distance from the object when capturing the image, or a position of the object on the display; the input equipment communicating the image, the image-capturing distance or the object position; the processing apparatus receiving the captured image, the image-capturing distance or the object position from the input equipment; the processing apparatus analyzing the captured image, the image-capturing distance or the object position to calculate an edge position of the image; and the processing apparatus converting the edge position, the captured image or the object position to an input signal.

According to an embodiment of the invention, the method further includes displaying the image on the display before the step of capturing the image by the input equipment.

According to an embodiment of the invention, the step of capturing an image by the input equipment is performed upon the input equipment being used to point toward the object.

According to an embodiment of the invention, the input equipment is configured to point toward the object by projecting a beam toward the object upon a control button or sensor of the input equipment being pressed.

According to an embodiment of the invention, the edge position of the image is calculated based on a boundary of the captured image determined by the processing apparatus analyzing the image-capturing distance or the object position.

According to an embodiment of the invention, the step of calculating the edge position of the image is based on the captured image continually captured by the input equipment.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a functional block diagram of an image input system according to an exemplary embodiment of the present invention.

FIG. 1B is a functional block diagram of an image input system according to an exemplary embodiment of the present invention.

FIG. 2 is a schematic diagram of performing a remote input operation according to an exemplary embodiment of the present invention.

FIG. 3 is a schematic diagram of a remote input operation according to the exemplary embodiment illustrated in FIG. 2.

FIG. 4 is a schematic diagram of a touch input operation according to an exemplary embodiment of the present invention.

FIG. 5 is a schematic diagram of a touch input operation according to the exemplary embodiment illustrated in FIG. 4.

FIG. 6 is a flow chart of an image input method according to an exemplary embodiment of the present invention.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

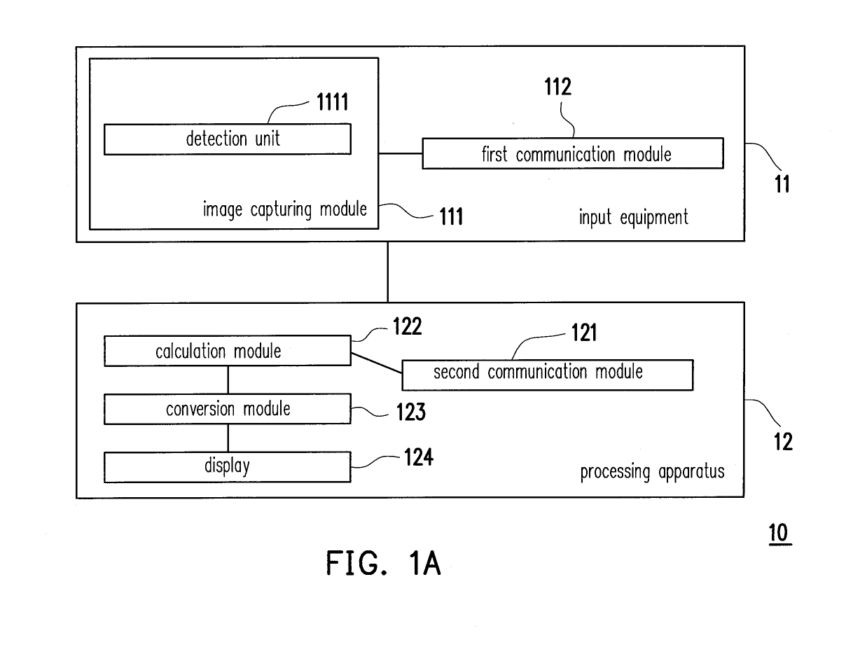

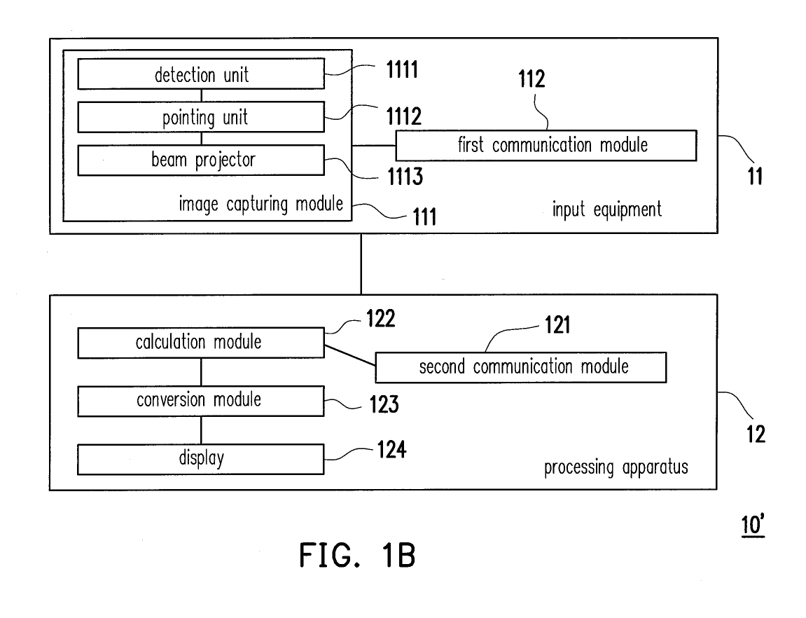

FIG. 1A is a functional block diagram of an image input system 10 according to an exemplary embodiment of the present invention. In the present embodiment, the image input system 10 includes an input equipment 11 and a processing apparatus 12. The input equipment 11 includes an image capturing module 111 and a first communication module 112. The image capturing module 111 includes a detection unit 1111 and is configured to capture an image of an object on a display 124 and optionally to point toward the object. If the image capturing module 111 is close to the object on the display 124, in a short distance input operation, pointing toward the object by the image capturing module 111 may include e.g. touching or clicking on the object on the display 124. The detection unit 1111 is configured to detect the distance between the image capturing module 111 and the object when the image capturing module 111 is capturing the image, or a position of the object on the display 124. The detection unit 1111 may include a camera and photodetectors such as complementary metal-oxide semiconductor (CMOS) or charge-coupled device (CCD), etc. The first communication module 112 is configured to communicate or transmit the captured image, the image-capturing distance or the object position.

The processing apparatus 12 includes a second communication module 121, a calculation module 122, a conversion module 123 and the display 124. The second communication module 121 is configured for receiving the captured image, the image-capturing distance or the object position from the first communication module 112. The calculation module 122 is configured to analyze the captured image, the image-capturing distance or the object position to calculate an edge position of the image. The conversion module 123 is configured to convert the edge position, the captured image or the object position to an input signal.

It is noted that the first transmission module 112 and the second transmission module 121 may be implemented by wired transmission standards such as USB, RS-232, and Ethernet, or may be implemented by wireless transmission standards such as Bluetooth, wireless local area network (WLAN), worldwide interoperability for microwave access (WiMAX), wireless fidelity (Wi-Fi) or long term evolution (LTE), etc.

FIG. 1B is a functional block diagram of an image input system 10′ according to an exemplary embodiment of the present invention. The image input system 10′ includes all of the components of the image input system 10 illustrated in FIG. 1A. In addition, the image capturing module 111 further includes a pointing unit 1112 and a beam projector 1113. The pointing unit 1112 is electrically connected to the detection unit 1111, and when the pointing unit 1112 is used to point toward the object, the detection unit 1111 may detect this operation and trigger the image capturing module 111 to capture the image. The pointing unit 1112 may include sensors or control buttons, which may be implemented by physical buttons or virtual buttons (e.g., touch buttons). The beam projector 1113 is electrically connected to the pointing unit 1112. When a control button or sensor of the pointing unit 1112 is pressed, the beam projector 1113 would project a beam toward the object. The beam may be, for example, a laser beam, which is not limited thereto. The processing apparatus 10 further includes a display 124, which is configured for displaying the image. The display 124 can be, for example, a liquid crystal display (LCD).

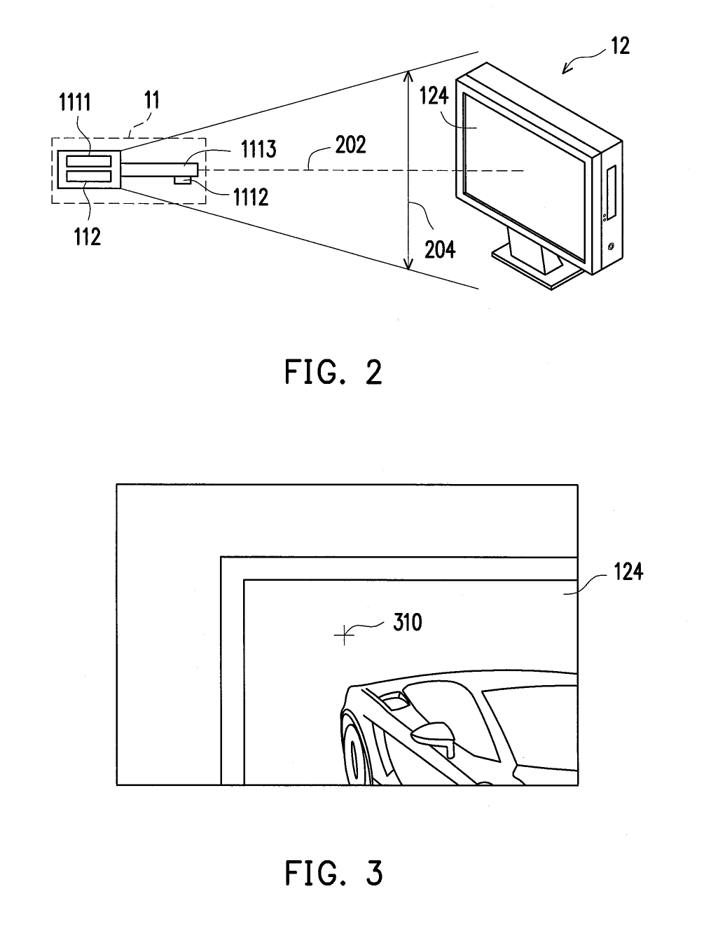

FIG. 2 is a schematic diagram of performing a remote input operation according to an exemplary embodiment of the present invention. In this embodiment, the user may perform wireless controlling by the collaborative operations of the input equipment 11 and the processing apparatus 12. For example, assuming that the input equipment 11 and the processing apparatus 12 are peripheral equipments of a computer, the user of the computer may use the input equipment 11 to perform operations originally accomplished by a mouse. When the input equipment 11 is placed far away from the processing apparatus 12. The user may control the beam projector 1113 to project a beam 202 (e.g., a laser beam) by triggering the pointing unit 1112 (e.g., by pressing the physical button of the pointing unit 1112). With the beam 202, the user may point to an object or a specific region (e.g., an icon or an option button) on the display 124. At this time, the input equipment 11 may use the image capturing module 111 to capture the image within a range 204, and therefore the image would include the screen of the display 124. Next, the detection unit 1111 would detect the distance between the input equipment 11 and the display 124, i.e., the image-capturing distance. Besides, the detection unit 1111 may also detect the position of the object on the display 124. Further, the first communication module 112 would transmit the image of the object, the detected image-capturing distance and the position of the object to the processing apparatus 12 to perform the following image processing operations.

After the second communication module 121 receives the captured image, the detected image-capturing distance and the object position from the first communication module 112, the calculation module 122 may analyze these information to obtain edge positions of the captured image. Hence, by the processing of the calculation module 122, the relative positions of the object and the edge positions of the image can be correspondingly obtained. Accordingly, the conversion module 123 can convert the aforementioned relative positions to retrieve the coordinate of the position pointed by the user and controls the display 124 to display items (e.g., a cursor) at the corresponding location.

In other embodiments, since the calculation of the edge positions is based on the previous image taken by the image capturing module 111, the image capturing module 111 may continually capture images to facilitate the calculation operations of the edge positions.

FIG. 3 is a schematic diagram of a remote input operation according to the exemplary embodiment illustrated in FIG. 2. In this embodiment, when the user wants to move, for example, a cursor on the display 124, the user may point to a desired position 310 on the display 124 with the beam 202 by triggering the pointing unit 1112, and the processing apparatus 12 would correspondingly move the cursor to the desired position after the corresponding operations of the components of the input equipment 11 and the processing apparatus 12.

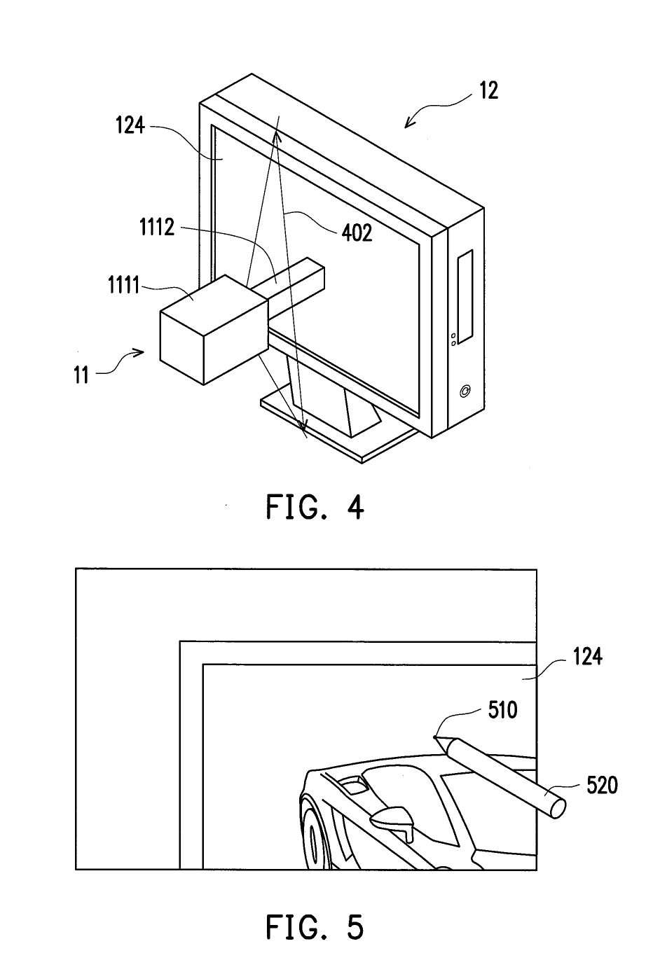

FIG. 4 is a schematic diagram of a touch input operation according to an exemplary embodiment of the present invention. In this embodiment, the user may directly input instructions (e.g., moving a cursor) by touching the display 124 with the input equipment 11, where the display 124 does not need to be a touch screen display. In the input equipment 11, a physical button may be disposed at the front of the pointing unit 1112. When the user uses the front of the pointing unit 1112 to touch the display 124, the physical button would be pressed to trigger the image-capturing module 111 and the detection unit 1111 to work as described in the embodiment illustrated in FIG. 2. Then, after the subsequent operations of the first communication module 112, the second communication module 121, the calculation module 122 and the conversion module 124, the display 124 could also display items (e.g., a cursor) at the corresponding location where the user points.

FIG. 5 is a schematic diagram of a touch input operation according to the exemplary embodiment illustrated in FIG. 4. In this embodiment, when the user wants to move, for example, a cursor on the display 124, the user may touch a desired position 510 on the display 124 with a stylus 520, and the processing apparatus 12 would correspondingly move the cursor to the desired position after the corresponding operations of the components of the input equipment 11 and the processing apparatus 12.

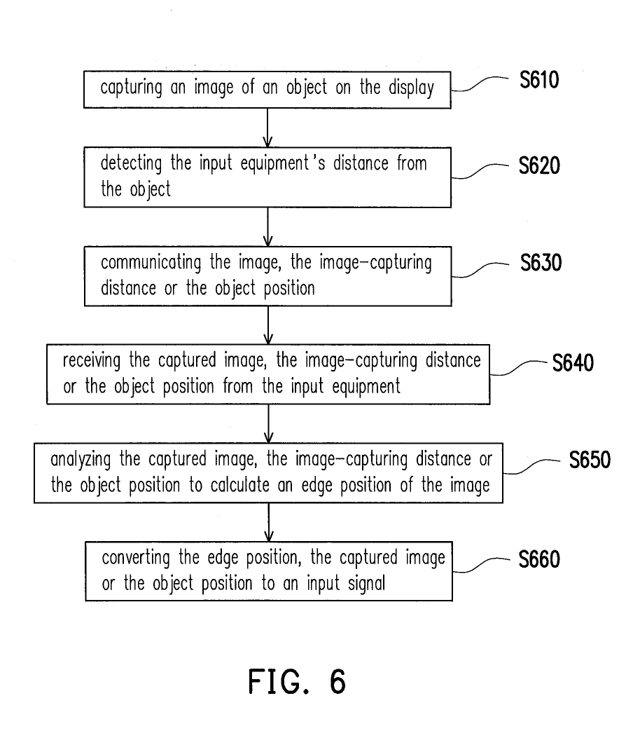

FIG. 6 is a flowchart of an image input method according to an exemplary embodiment of the present invention. Referring to both FIG. 1 and FIG. 6, the proposed image input method may be adapted for the foregoing image input system 10, but the invention is not limited thereto. In step S610, the input equipment 11 captures an image of an object on the display 124, wherein the input equipment 11 is configured to point toward the object. In step S620, the input equipment 11 detects the input equipment 11's distance from the object when the input equipment 11 is capturing the image, or a position of the object on the display. In step S630, the input equipment 11 communicates the image, the image-capturing distance or the object position. In step S640, the processing apparatus 12 receives the captured image, the image-capturing distance or the object position from the input equipment 11. In step S650, the processing apparatus 12 analyzes the captured image, the image-capturing distance or the object position to calculate an edge position of the image. In step 660, the processing apparatus 12 converts the edge position, the captured image or the object position to an input signal.

In summary, embodiments of the present invention provides an image input system and image input method thereof. By the mechanism of the collaborative operations of the input equipment and the processing apparatus, the user may input instructions such as moving cursors in a more intuitive way by simply pointing or touching the corresponding position on the display. Hence, a new type of human-machine interface implemented by image capturing is provided.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image input system with a display, the image input system including:
an input equipment, comprising:
an image capturing module, comprising a detection unit and configured to capture an image of an object on the display and optionally to point toward the object, wherein the detection unit is configured to detect the image capturing module's distance from the object when capturing the image, or a position of the object on the display; and
a first communication module, configured to communicate the captured image, the image-capturing distance or the object position; and
a processing apparatus, comprising:
a second communication module, configured to receive the captured image, the image-capturing distance or the object position from the first communication module;
a calculation module, configured to analyze the captured image, the image-capturing distance or the object position to calculate an edge position of the image; and
a conversion module, configured to convert the edge position, the captured image or the object position to an input signal.

2. The image input system as claimed in claim 1, wherein the processing apparatus includes the display for displaying the image.

3. The image input system as claimed in claim 2, wherein the image capturing module comprises a pointing unit electrically connected to the detection unit, and the image capturing module is configured to capture the image upon the detection unit detecting that the pointing unit is used to point toward the object.

4. The image input system as claimed in claim 3, wherein the image capturing module comprises a beam projector, electrically connected to the pointing unit, and the beam projector is configured to project a beam toward the object upon a control button or sensor of the pointing unit being pressed.

5. The image input system as claimed in claim 1, wherein the edge position of the image is calculated based on a boundary of the captured image determined by the calculation module analyzing the image-capturing distance or the object position.

6. The image input system as claimed in claim 1, wherein the calculation module is configured to calculate the edge position of the image based on the captured image continually captured by the image capturing module.

7. An image input method applicable to an image input system including an input equipment and a processing apparatus including a display, the image input method comprising:
the input equipment capturing an image of an object on the display wherein the input equipment is configured to point toward the object;
the input equipment detecting the input equipment's distance from the object when capturing the image, or a position of the object on the display;
the input equipment communicating the image, the image-capturing distance or the object position;
the processing apparatus receiving the captured image, the image-capturing distance or the object position from the input equipment;
the processing apparatus analyzing the captured image, the image-capturing distance or the object position to calculate an edge position of the image; and
the processing apparatus converting the edge position, the captured image or the object position to an input signal.

8. The image input method as claimed in claim 7, wherein before the step of capturing an image by the input equipment, the method further comprising:
displaying the image on the display.

9. The image input method as claimed in claim 7, wherein the step of capturing an image by the input equipment is performed upon the input equipment being used to point toward the object.

10. The image input method as claimed in claim 7, wherein the input equipment is configured to point toward the object by projecting a beam toward the object upon a control button or sensor of the input equipment being pressed.

11. The image input method as claimed in claim 7, wherein the edge position of the image is calculated based on a boundary of the captured image determined by the processing apparatus analyzing the image-capturing distance or the object position.

12. The image input method as claimed in claim 7, wherein calculating the edge position of the image is based on the captured image continually captured by the input equipment.
